(19) United States
(12) Patent Application Publication
(10) Pub. No.: US 2026/0243954 A1
(43) Pub. Date: Aug. 20, 2026

(54) ADIABATIC MODE CONVERSION BY A DOUBLE-SIDED TAPERING STRUCTURE OF AMORPHOUS SILICON

(71) Applicant: II-VI Delaware, Inc., Wilmington, DE (US)

(72) Inventors: Masafumi Ayata, Wilmington, DE (US); Young-Kai Chen, Wilmington, DE (US); Peter Szabo, Wilmington, DE (US); David Adams, Wilmington, DE (US); Martin Stattin, Wilmington, DE (US); Jan-Olof Wesstroem, Wilmington, DE (US); Robert Lewen, Wilmington, DE (US); Staffan D. Hellstrom, Wilmington, DE (US); Nicolae P. Chitica, Wilmington, DE (US); Odd R. Steijer, Wilmington, DE (US)

(21) Appl. No.: 19/058,915

(22) Filed: Feb. 20, 2025

(51) Int. Cl. G02B 6/122; G02B 6/12; G02B 6/125

(52) U.S. Cl. CPC G02B 6/1228; G02B 6/1223; G02B 6/125; G02B 2006/12078; G02B 2006/12147; G02B 2006/12152

(57) ABSTRACT

Embodiments of the present disclosure may include a system to couple waveguides of different confinement materials, the system including a first waveguide and a second waveguide coupled in a transition area using suitably tapered areas.

### TECHNICAL FIELD

The present disclosure generally relates to an adiabatic mode conversion by a double-sided tapering structure.

### BACKGROUND

Aspects of the present disclosure relate to an adiabatic mode conversion by a double-sided tapering structure. Various issues may exist with conventional solutions for mode conversion. In this regard, conventional coherent transceivers may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

BRIEF SUMMARY OF THE DISCLOSURE

Shown in and/or described in connection with at least one of the figures, and set forth more completely in the claims is an adiabatic mode conversion by a double-sided tapering structure.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 is a block diagram illustrating a system, according to some embodiments of the present disclosure.

FIG. 2 is a cross-section of a system, according to some embodiments of the present disclosure.

FIG. 3 is a three-dimensional depiction of a system, according to some embodiments of the present disclosure.

### DESCRIPTION

The following discussion provides various examples of a system for an adiabatic mode conversion by a double-sided tapering structure. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Embodiments of the present disclosure may comprise a system to couple waveguides, the system comprising a first waveguide comprising a first material and a first cross-sectional area. Embodiments may also comprise a second waveguide comprising a second material and a second cross-sectional area. In some embodiments, the second cross-sectional area may be smaller than the first cross-sectional area. Embodiments may also comprise a transition area. In some embodiments, the first waveguide abuts the second waveguide. The transition area may comprise a first taper of the first waveguide, the first taper narrowing toward the second waveguide. Embodiments may also comprise a second taper of the second waveguide, the second taper narrowing away from the first waveguide.

In some embodiments, the first waveguide and the second waveguide may be on a common substrate. In some embodiments, the common substrate may be indium phosphide (InP) or InP-based. In some embodiments, the second material may be deposited on the common substrate. In some embodiments, the first material may be indium phosphide gallium arsenide (InPGaAs) or InP-based or a III-V material.

In some embodiments, the second material may be amorphous silicon (aSi) or aSi-based. In some embodiments, the first material may be a low confinement material. In some embodiments, the second material may be a high confinement material. In some embodiments, the first taper may comprise a sloping plane forming a ramp.

In some embodiments, the first taper may comprise a wedge-shape. In some embodiments, the first taper may comprise a funnel-shape. In some embodiments, the second taper may comprise a sloping plane forming a ramp-shape. In some embodiments, the second taper may comprise a wedge-shape.

In some embodiments, the second taper may comprise a funnel-shape. In some embodiments, the first and/or the second taper can be configured to narrow in one or more dimensions. In some embodiments, the transition area may be operable to couple the first waveguide to the second waveguide with low optical loss.

In some embodiments, the transition area may be operable to adiabatically convert a mode between the first waveguide and the second waveguide. In some embodiments, the first waveguide may be coupled to a laser, a distributed feedback laser, a transmitter, a modulator, a Mach-Zehnder modulator, a detector, a converter, a spot-size converter, a semiconductor optical amplifier, a switch or any other active component.

Silicon photonics may be the dominating approach to implement many optical electronics. One drawback, however, may be the lack of active components, including lasers. Thus, it may be desirable to integrate silicon photonics with other semiconductor technologies more suitable for active componentry. This disclosure illustrates an exemplary hybrid integration of silicon photonics with indium phosphide (InP) semiconductors. InP may be suitable for active components, but may be less advantageous for high index contrast passive waveguides. High index contrast passive waveguides would permit tight radiuses and small cross-sections. This may, in turn, permit small components and thus a small footprint. Amorphous silicon may be one option for high index contrast passive waveguides. For this reason, it may be advantageous to combine passive waveguides made from amorphous silicon (aSi) with InP waveguides leading from and to InP-based active components. Compared to an all InP-based circuitry, the area required of the hybrid approach disclosed may be much smaller, permitting smaller components and more active components per unit area.

For example, aSi structures may be formed on a common InP or InP-based substrate using deposition techniques.

This disclosure shows how a low optical loss transition from a first waveguide 110 based on InP to a second waveguide 120 based on aSi may be achieved through a transition area 130.

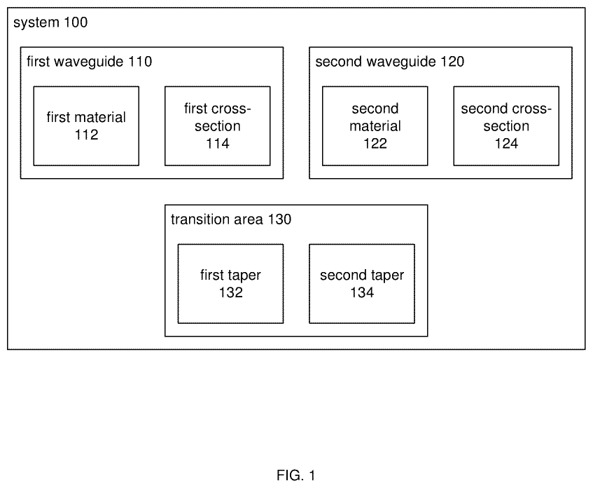

Referring now to FIG. 1, FIG. 1 is a block diagram that describes a system 100, according to some embodiments of the present disclosure. In some embodiments, the system 100 may comprise a first waveguide 110, a second waveguide 120, and a transition area 130. The first waveguide 110 may comprise a first material 112 and a first cross-sectional area 114. The second waveguide 120 may comprise a second material 122 and a second cross-sectional area 124. The second cross-sectional area 124 may be smaller than the first cross-sectional area 114. The transition area 130 may also comprise a first taper 132 of the first waveguide 110, the first taper 132 narrowing toward the second waveguide 120. The transition area 130 may also comprise a second taper 134 of the second waveguide 120, the second taper 134 narrowing away from the first waveguide 110. The first waveguide 110 may abut the second waveguide 120 in the transition area 130.

In some embodiments, the first waveguide 110 and the second waveguide 120 may be on a common substrate. In some embodiments, the common substrate may be InP or InP-based. In some embodiments, the second material 122 may be deposited on the common substrate. In some embodiments, the first material 112 may be InPGaAs or InP-based or a III-V material. In some embodiments, the second material 122 may be aSi or aSi-based.

In some embodiments, the first material 112 may be a low confinement material. In some embodiments, the second material 122 may be a high confinement material. In some embodiments, the first taper 132 may comprise a sloping plane forming a ramp. In some embodiments, the first taper 132 may comprise a wedge-shape. In some embodiments, the first taper 132 may comprise a funnel-shape. In some embodiments, the second taper 134 may comprise a sloping plane forming a ramp-shape.

In some embodiments, the second taper 134 may comprise a wedge-shape. In some embodiments, the second taper 134 may comprise a funnel-shape. In some embodiments, the first and/or the second taper 134 can be configured to narrow in one or more dimensions. In some embodiments, the transition area 130 may be operable to couple the first waveguide 110 to the second waveguide 120 with low optical loss. In some embodiments, the transition area 130 may be operable to adiabatically convert a mode between the first waveguide 110 and the second waveguide 120. In some embodiments, the first waveguide 110 may be coupled to a laser, a distributed feedback laser, a transmitter, a modulator, a Mach-Zehnder modulator, a detector, a converter, a spot-size converter, a semiconductor optical amplifier, a switch or any other active component.

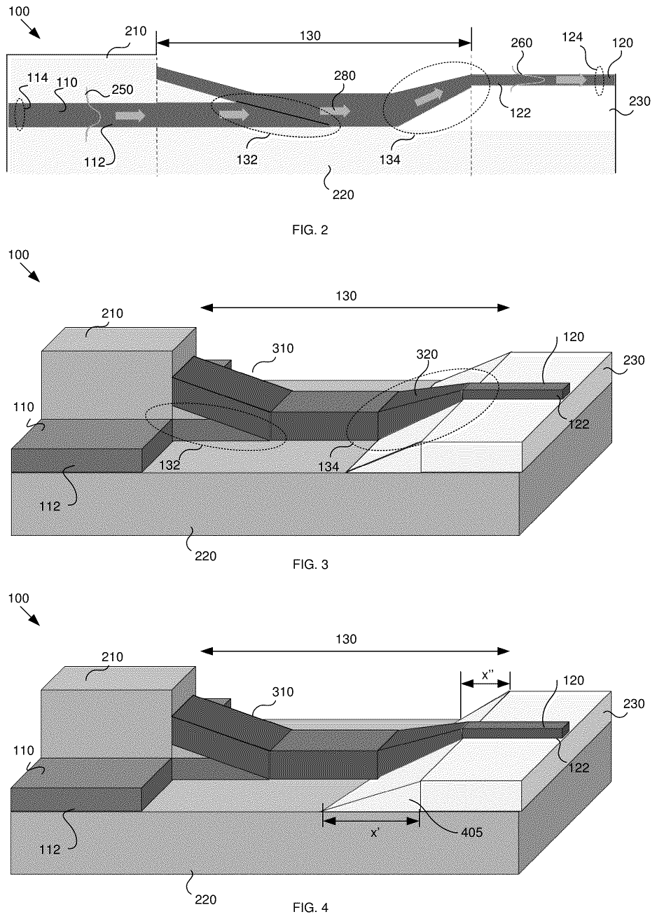

FIG. 2 is a cross-section of a system 100, according to some embodiments of the present disclosure. In some embodiments, the system 100 may comprise a first waveguide 110, a second waveguide 120, and a transition area 130. The first waveguide 110 may comprise a first material 112 and a first cross-sectional area 114. The second waveguide 120 may comprise a second material 122 and a second cross-sectional area 124. The second cross-sectional area 124 may be smaller than the first cross-sectional area 114. The transition area 130 may also comprise a first taper 132 of the first waveguide 110, the first taper 132 narrowing toward the second waveguide 120. The transition area 130 may also comprise a second taper 134 of the second waveguide 120, the second taper 134 narrowing away from the first waveguide 110. The first waveguide 110 may abut the second waveguide 120 in the transition area 130.

In some embodiments, the first waveguide 110 and the second waveguide 120 may be on a common substrate 220. In some embodiments, the common substrate 220 may be InP or InP-based. The common substrate 220 may inherently be low confinement. In some embodiments, the second material 122 may be deposited on the common substrate 220. In some embodiments, the first material 112 may be InPGaAs or InP-based or a III-V material. The first waveguide 110 may be formed between the common substrate 220 and a first top layer 210. The first top layer 210 may be InP or InP-based, similar or identical to the common substrate 220, for example. In some embodiments, the second material 122 may be aSi or aSi-based. The second material 122 may inherently be high confinement.

In some embodiments, the first material 112 may be a low confinement material. In some embodiments, the second material 122 may be a high confinement material. A second top layer 230, e.g., under the second waveguide 120, may be made from silicon, for example. The symbolic depiction 250 may illustrate that an optical signal may be carried across the cross-section 114 of the first waveguide 110 in low confinement mode. The symbolic depiction 260 may illustrate that a similar optical signal may be carried across the cross-section 124 of the second waveguide 120 in high confinement mode. The symbolic arrow 280 may illustrate an optical signal transition from a first waveguide 110 to a second waveguide 120. In some embodiments, the first taper 132 may comprise a sloping plane forming a ramp. In some embodiments, the first taper 132 may comprise a wedge-shape. In some embodiments, the first taper 132 may comprise a funnel-shape. In some embodiments, the second taper 134 may comprise a sloping plane forming a ramp-shape.

In some embodiments, the second taper 134 may comprise a wedge-shape. In some embodiments, the second taper 134 may comprise a funnel-shape, as illustrated in FIG. 2 and FIG. 3. In some embodiments, the first and/or the second taper 134 can be configured to narrow in one or more dimensions. In some embodiments, the transition area 130 may be operable to couple the first waveguide 110 to the second waveguide 120 with low optical loss. In some embodiments, the transition area 130 may be operable to adiabatically convert a mode between the first waveguide 110 and the second waveguide 120. In some embodiments, the first waveguide 110 may be coupled to a laser, a distributed feedback laser, a transmitter, a modulator, a Mach-Zehnder modulator, a detector, a converter, a spot-size converter, a semiconductor optical amplifier, a switch or any other active component. None of the active components are illustrated in FIG. 2.

FIG. 3 is a three-dimensional depiction of a system, according to some embodiments of the present disclosure. FIG. 3 further illustrates an embodiment similar to that shown in the cross-section of FIG. 2, particularly the transition area 130.

The transition area 130 may comprise a first taper 132 of the first waveguide 110, the first taper 132 narrowing toward the second waveguide 120. The transition area 130 may also comprise a second taper 134 of the second waveguide 120, the second taper 134 narrowing away from the first waveguide 110. The first waveguide 110 may abut the second waveguide 120 in the transition area 130.

In some embodiments, the first material 112 may be a low confinement material. In some embodiments, the second material 122 may be a high confinement material. It may be seen in FIG. 3 that the first waveguide 110 may have a substantially larger cross-sectional area than the second waveguide 120.

In some embodiments, the first taper 132 may comprise a sloping plane 310 forming a ramp and/or a wedge-shape, as shown in FIG. 3. For example, as shown in FIG. 3, the second taper 134, the second taper 134 may comprise a funnel-shape 320, narrowing in the direction away from the low confinement first waveguide 110 towards the high confinement second waveguide 120.

The present disclosure comprises reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will comprise all examples falling within the scope of the appended claims.

What is claimed is:

1. A system to couple waveguides, said system comprising:
a first waveguide comprising a first material and a first cross-sectional area;
a second waveguide comprising a second material and a second cross-sectional area, wherein said second cross-sectional area is smaller than said first cross-sectional area;
a transition area, wherein said first waveguide abuts said second waveguide, said transition area comprising:
a first taper of said first waveguide, said first taper narrowing toward said second waveguide;
a second taper of said second waveguide, said second taper narrowing away from said first waveguide;

2. The system of claim 1, wherein said first waveguide and said second waveguide are on a common substrate.

3. The system of claim 2, wherein said common substrate is InP or InP-based.

4. The system of claim 2, wherein said second material is deposited on said common substrate.

5. The system of claim 1, wherein said first material is InPGaAs or InP-based or a III-V material.

6. The system of claim 1, wherein said second material is aSi or aSi-based.

7. The system of claim 1, wherein said first material is a low confinement material.

8. The system of claim 1, wherein said second material is a high confinement material.

9. The system of claim 1, wherein said first taper comprises a sloping plane forming a ramp.

10. The system of claim 1, wherein said first taper comprises a wedge-shape.

11. The system of claim 1, wherein said first taper comprises a funnel-shape;

12. The system of claim 1, wherein said second taper comprises a sloping plane forming a ramp-shape.

13. The system of claim 1, wherein said second taper comprises a wedge-shape.

14. The system of claim 1, wherein said second taper comprises a funnel-shape;

15. The system of claim 1, wherein said first and/or said second taper can be configured to narrow in one or more dimensions.

16. The system of claim 1, wherein said transition area is operable to couple said first waveguide to said second waveguide with low optical loss.

17. The system of claim 1, wherein said transition area is operable to adiabatically convert a mode between said first waveguide and said second waveguide.

18. The system of claim 1, wherein said first waveguide is coupled to a laser, a distributed feedback laser, a transmitter, a modulator, a Mach-Zehnder modulator, a detector, a converter, a spot-size converter, a semiconductor optical amplifier, a switch or any other active component.
